(19) United States
(12) Patent Application Publication
(10) Pub. No.: US 2021/0097364 A1
(43) Pub. Date: Apr. 1, 2021

(54) RFID SCREW SPECIFICALLY FOR USE ON EYEGLASS FRAMES

(71) Applicant: PAUL SALSBERG, TORONTO (CA)

(72) Inventor: PAUL SALSBERG, TORONTO (CA)

(21) Appl. No.: 16/852,499

(22) Filed: Apr. 19, 2020

Related U.S. Application Data
(63) Continuation-in-part of application No. 16/276,238, filed on Feb. 14, 2019, now Pat. No. 10,719,748.

(51) Int. Cl. G06K 19/077; G06K 19/07; G08B 13/24; G06Q 10/08

(52) U.S. Cl. CPC G06K 19/07786; G06K 19/07788; G06Q 10/087; G06K 19/0723; G08B 13/2417; G06K 19/07762

(57) ABSTRACT

The embodiments of the present invention are an RFID device including an RFID tag, an antenna, and a programmable logic. The RFID tag is inside a custom screw of an eyeglass frame configured to track and identify the eyeglass frame. The antenna is inside the custom screw of the eyeglass frame configured to receive a transmitted signal to collect and power the RFID tag. The programmable logic is inside the custom screw of the eyeglass frame configured to process and store transmission and sensor data. Barcodes are eliminated because a person using a barcode reader has the burden of scanning every item one-by-one, and assuring that the tag is within the line of sight of the reader.

### CROSS REFERENCE TO RELATED APPLICATIONS

The instant non-provisional patent application is a Continuation-In-Part non-provisional patent application of non-provisional patent application Ser. No. 16/276,238, filed on 14 Feb. 2019, in group art unit 2876, and entitled RFID SCREW SPECIFICALLY FOR USE ON EYEGLASS FRAMES, which claims priority from provisional patent application No. 62/636,806, filed on 28 Feb. 2018, and entitled RFID SCREW SPECIFICALLY FOR USE ON EYEGLASS FRAMES, and are all incorporated herein in their entireties by reference thereto.

### BACKGROUND OF THE INVENTION

### Field of the Invention

The embodiments of the present invention relate to an RFID screw, and more particularly, the embodiments of the present invention relate to an RFID screw, specifically for use on eyeglass frames.

### Description of the Prior Art

### General

Radio-frequency identification (RFID) uses electromagnetic fields to automatically identify and track tags attached to objects. The tags contain electronically-stored information. Passive tags collect energy from nearby RFID reader's interrogating radio waves. Active tags have a local power source, such as, a battery, and may operate hundreds of meters from the RFID reader. Unlike a barcode, the tag need not be within the line of sight of the reader, so it may be embedded in the tracked object. RFID is one method for Automatic Identification and Data Capture (AIDC).

RFID tags are used in many industries, for example, an RFID tag attached to an automobile during production can be used to track its progress through the assembly line. RFID-tagged pharmaceuticals can be tracked through warehouses. And, implanting RFID microchips in livestock and pets allows for positive identification of animals.

Since RFID tags can be attached to cash, clothing, and possessions, or implanted in animals and people, the possibility of reading personally-linked information without consent has raised serious privacy concerns. These concerns resulted in standard-specifications-development addressing privacy and security issues. ISO/IEC 18000 and ISO/IEC 29167 use on-chip cryptography methods for traceability, tag and reader authentication, and over-the-air privacy. ISO/IEC 20248 specifies a digital signature data structure for an RFID and barcodes providing data, source, and read method authenticity. This work is done within ISO/IEC JTC 1/SC 31 Automatic identification and data capture techniques. Tags can also be used in shops to expedite checkout, and to prevent theft by customers and employees.

### Tags

A radio-frequency identification system uses tags or labels attached to the objects to be identified. Two-way radio transmitter-receivers called interrogators or readers send a signal to the tag and read its response.

RFID tags can be either passive, active, or battery-assisted passive. An active tag has an on-board battery and periodically transmits its ID signal. A battery-assisted passive (BAP) has a small battery on board and is activated when in the presence of an RFID reader. A passive tag is cheaper and smaller because it has no battery. Instead, the tag uses the radio energy transmitted by the reader. To operate a passive tag, however, it must be illuminated with a power level roughly a thousand times stronger than for signal transmission. That makes a difference in interference and in exposure to radiation.

Tags may either be read-only, having a factory-assigned serial number that is used as a key into a database, or may be read/write where object-specific data can be written into the tag by the system user. Field programmable tags may be write-once and read-multiple. “Blank” tags may be written with an electronic product code by the user.

RFID tags contain at least three parts: an integrated circuit for storing and processing information that modulates and demodulates radio-frequency (RF) signals; apparatus for collecting the AC power from the incident reader signal; and an antenna for receiving and transmitting the signal. The tag information is stored in a non-volatile memory. The RFID tag further includes either fixed or programmable logic for processing the transmission and sensor data, respectively.

An RFID reader transmits an encoded radio signal to interrogate the tag. The RFID tag receives the message and then responds with its identification and other information. This may be only a unique tag serial number, or may be product-related information, such as, a stock number, a lot or batch number, a production date, or other specific information. Since tags have individual serial numbers, the RFID system design can discriminate among several tags that might be within the range of the RFID reader, and read them simultaneously.

Examples of prior art RFID tags 10 and 12 can be seen in FIGS. 1 and 2, respectively.

The common sizes of screws in mm include at least:

1.4×4.0×2.0 1.4×4.0×1.8 1.2×4.0×1.8 1.5×4.0×2.0 1.4×4.8×2.0 1.5×4.0×1.8 1.3×4.0×1.8 1.5×4.0×2.5 1.4×4.8×2.5 1.4×4.0×2.5

### Readers

RFID systems can be classified by the type of tag and reader. A Passive Reader Active Tag (PRAT) system has a passive reader that only receives radio signals from active tags battery operated, transmit only. The reception range of a PRAT system reader can be adjusted from 1-2,000 feet (0-600 m), allowing flexibility in applications, such as, asset protection and supervision.

An Active Reader Passive Tag (ARPT) system has an active reader that transmits interrogator signals and also receives authentication replies from passive tags.

An Active Reader Active Tag (ARAT) system uses active tags awoken with an interrogator signal from the active reader. A variation of this system could also use a Battery-Assisted Passive (BAP) tag which acts like a passive tag, but has a small battery to power the tag's return reporting signal.

Fixed readers are set up to create a specific interrogation zone that can be tightly controlled. This allows a highly defined reading area for when tags go in and out of the interrogation zone. Mobile readers may be hand-held or mounted on carts or vehicles.

### Signaling

Signaling between the reader and the tag is done in several different incompatible ways, depending on the frequency band used by the tag. Tags operating on LF and HF bands are, in terms of radio wavelength, very close to the reader antenna because they are only a small percentage of a wavelength away. In this near field region, the tag is closely coupled electrically with the transmitter in the reader. The tag can modulate the field produced by the reader by changing the electrical loading the tag represents. By switching between lower and higher relative loads, the tag produces a change that the reader can detect. At UHF and higher frequencies, the tag is more than one radio wavelength away from the reader, requiring a different approach. The tag can backscatter a signal. Active tags may contain functionally separated transmitters and receivers, and the tag need not respond on a frequency related to the reader's interrogation signal.

An Electronic Product Code (EPC) is one common type of data stored in a tag. When written into the tag by an RFID printer, the tag contains a 96-bit string of data. The first eight bits are a header that identifies the version of the protocol. The next 28 bits identify the organization that manages the data for the tag. The organization number is assigned by the EPC Global consortium. The next 24 bits are an object class, identifying the kind of product. The last 36 bits are a unique serial number for a particular tag. These last two fields are set by the organization that issued the tag. Rather like a URL, the total electronic product code number can be used as a key into a global database to uniquely identify a particular product.

Often more than one tag will respond to a tag reader. For example, many individual products with tags may be shipped in a common box or on a common pallet. Collision detection is important to allow reading of data. Two different types of protocols are used to “singulate” a particular tag, allowing its data to be read in the midst of many similar tags. In a slotted Aloha system, the reader broadcasts an initialization command and a parameter that the tags individually use to pseudo-randomly delay their responses. When using an “adaptive binary tree” protocol, the reader sends an initialization symbol and then transmits one bit of ID data at a time. Only tags with matching bits respond, and eventually only one tag matches the complete ID string.

An example of a binary tree method of identifying an RFID tag 14 is shown in FIG. 3.

Both methods have drawbacks when used with many tags or with multiple overlapping readers. Bulk reading is a strategy for interrogating multiple tags at the same time, but lack sufficient precision for inventory control.

### And Most Importantly—Miniaturization

RFIDs are easy to conceal or incorporate in other items. For example, in 2009 researchers at Bristol University successfully glued RFID micro-transponders to live ants in order to study their behavior. This trend towards increasingly miniaturized RFIDs is likely to continue as technology advances.

Hitachi holds the record for the smallest RFID chip, at 0.05 mm×0.05 mm. This is 1/64^{th} the size of the previous record holder, the mu-chip. Manufacture is enabled by using the silicon-on-insulator (SOI) process. These dust-sized chips can store 38-digit numbers using 128-bit Read Only Memory (ROM). A major challenge is the attachment of antennas, thus limiting read range to only millimeters.

Numerous innovations for RFID devices have been provided in the prior art, which are adapted to be used, and which are discussed, infra, in chronological order to show advancement in the art. Furthermore, even though these innovations may be suitable for the specific individual purposes to which they address, they would not be suitable for the purposes of the embodiments of the present invention as heretofore described, namely, an RFID screw specifically for use on eyeglass frames.

### European Patent Application Publication Number EP0535919 to Ryan

European patent application publication number EP0535919—published to Ryan on Apr. 7, 1993 in Int. Class G06K and subclass 7/08 teaches a method for identifying a penetrable member, such as, a rail-road tie, utility pole, pallet, standing tree, or the like. A passive or active-transponder is encoded with identification information and placed within an accommodating receptacle in a nail, screw, bolt, or small fastener. The fastener is inserted into the penetrable member by use of a nail gun, drill, hammer, or other suitable device. Identification information stored in the transponder is read after insertion to identify the penetrable member.

### United States Patent Application Publication Number 2004/0227219 to Su

United States patent application publication number 2004/0227219—published to Su on Nov. 18, 2004 in U.S. Class 257 and subclass 679—teaches an intelligent tag for glasses, which is composed of a chip, a coil, and a printed circuit board. The intelligent tag is joined to, or embedded to, the glasses. The chip is provided with an internal memory and is recorded with digital data that is encoded from messages with regard to a company making the glasses and personal data of a wearer of the glasses by way of wireless-induction-burning-technique. The digital data can be read out and decoded with a reader by way of wireless accessing, and the decoded messages can be sent to a personal computer for further use.

### United States Patent Application Publication Number 2006/0187044 to Fabian et al.

United States patent application publication number 2006/0187044—published to Fabian et al. on Aug. 24, 2006 in U.S. class 340 and subclass 572.1—teaches a detector system for detecting a plurality of items, each having at least one RFID tag attached thereto. The detector system may include a presence detector and/or a message detector. The presence detector includes a signal reader that receives modulated carrier frequencies from the RFID tags during a predetermined response time period for comparison to a reference level. The signal reader is configured as a power integrator or a constellation discriminator. The power integrator sums the power contained in signals transmitted by the RFID tags by integration for comparison to an environmental noise level measurement taken during a quiet period. For the constellation discriminator, bits contained in the modulating message are compared to the bit pattern of a predetermined reference constellation. The detector system is configured as a 3-state detector that combines the presence detector with a message detector that indicates the identification code of the RFID tags.

In contradistinction to the present invention, Fabian et al. teach at the following location(s):

### Of Fabian et al.

The RFID marker can be very small in size and is typically encapsulated in glass or inert polymer making it able to withstand cleaning and sterilization operations.

### Of Fabian et al.

This small RFID marker has an antenna which couples with the interrogating antenna of the detection unit;

A power burst from the interrogating antenna charges a capacitor located within the RFID marker;

The charged capacitor then powers the logic and processing functions of an integrated chip, which reads a burned-in code present in the read-only memory thereof or the code in its user programmable memory; and

A carrier frequency is used for communication between the RFID marker and the interrogating antenna of the detector.

### Of Fabian et al.

RFID tags generally operate at frequencies ranging from 30 kHz to 2.45 GHz.

### Of Fabian et al.

An implement thus equipped with such an RFID marker can be readily identified by a stationary scanner mounted upon a rollaway cart or by an accompanying hand-held scanner;

A receiving unit detects an RFID signal emitted by the marker; and

The signal represents a particular code which allows immediate identification of a so-marked surgical implements remaining within the surgical cavity before closure of the surgical incision.

### Of Fabian et al.

This RFID marker includes a miniature integrated electronic circuit connected to an antenna, which is typically a copper wire wound over a ferrite core;

A capacitor circuit acts as a power source when charged by the electromagnetic radiation power burst emitted by an interrogating antenna of a detecting remote unit;

The antenna of the RFID marker first couples with the interrogating antenna of the detecting remote unit, which may be a hand-held scanner or a fixed scanner situated adjacent to the operating table;

An incoming burst of electromagnetic radiation is used to charge the capacitor. Upon being charged, the capacitor provides power to the integrated circuit, which reads a digital code that is permanently burned in the memory of the integrated circuit, and synthesizes a broadcast signal which modulates the carrier signal using pulse width modulation, pulse position modulation, or frequency shift keying modulation;

Digital data of the code is transmitted to the hand-held antenna or to the fixed remote antenna using the same detection unit; and

Since the digital code representing a given surgical implement cannot be generated by other than the particular RFID device implanted, detection is highly specific and there is no room for error.

### Of Fabian et al.

The RFID tag or marker is an integrated circuit with a burned-in digital code in a read-only or user programmable memory;

It is powered by a capacitor circuit that is connected to an antenna, which typically comprises a ferrite element wound with copper wire; and

When the RFID tag or marker is in the presence of electromagnetic radiation, the antenna couples with the interrogating electromagnetic radiation, charges the capacitor, and powers the integrated circuit, which accesses the burned-in digital code.

### Of Fabian et al.

Referring to FIG. 5, there is shown generally at 50 certain details involving attachment of an RFID radiofrequency marker to metallic instrument 35, a surgical retractor.

### Of Fabian et al.

The interrogation signal from the antenna may be attached to a remote and fixed detection system or the hand-held antenna attached to the same system charging the capacitor circuit of the radiofrequency marker in order to provide power for operation of the integrated circuit.

### United States Patent Application Publication Number 2009/0078762 to Forster

United States patent application publication number 2009/0078762—published to Forster on Mar. 26, 2009 in U. S. Class 235 and subclass 385—teaches an attachable RFID tag having a containment head portion containing a passive RFID transponder and an attachment portion including an elongate projection extending therefrom. The projection is discontinuously threaded, with a screw-threaded portion and an unthreaded portion of longitudinal extent greater than the thickness of the item to be tagged. A tagging system, a method of tagging, and of operating a tagging system are also taught.

### U.S. Pat. No. 7,651,217 to Welchel et al.

U.S. Pat. No. 7,651,217—issued to Welchel et al. on Jan. 26, 2010 in U.S. class 351 and subclass 115—teaches eyewear having a fit that may be used for safety, sports, and the like. The eyewear may provide features that permit enhanced airflow and an enhanced fit to a user's face. These features may include greater adjustability to provide greater comfort. Eyewear including an RFID tag is activated to send or receive transmissions when the eyewear is unfolded and/or positioned in a position to be worn by a user.

### U.S. Pat. No. 8,035,518 to Kolton et al.

U.S. Pat. No. 8,035,518—issued to Kolton et al. on Oct. 11, 2011 in U.S. class 340 and subclass 572.1—teaches an electronic tag housing that secures an electronic tag to an elongate article. The housing includes a cover and a base positioned over the cover for supporting the tag therebetween. The cover and base define a passageway therebetween for insertable receipt of the elongate article. A pressure plate is movably secured to the cover. The pressure plate is movable into engagement with the elongate article to clamp the article therein.

### United States Patent Application Publication Number 2012/0298758 to Vishwanath

United States patent application publication number 2012/0298758—published to Vishwanath on Nov. 29, 2012 in U.S. class: 235 and subclass 492—teaches systems and methods including implanting RFID tags into metal-containing objects. The RFID tags are coated in a heat-resistant coating. The surface of the metal-containing object could be heated and the coated RFID tag could be injected into the metal-containing object by allowing less heat to be transferred to the RFID electronics than an amount of heat to destroy the RFID electronics. The metal-containing objects are monitored and tracked. Apparatus with implanted metal-containing objects are remotely monitored and controlled.

In contradiction to the present invention, Vishwanath teaches at the following location(s):

### Of Vishwanath

FIG. 5 is a schematic diagram illustration of an embodiment comprising a coated RFOD tag embedded in a screw.

### Of Vishwanath

Another embodiment relates to an apparatus comprising a plurality of objects, at least one of the plurality of objects comprising an electronic circuit encapsulated in a heat resistant coating. The heat resistant coating encapsulating the electronic circuit configured to protect the electronic circuit from heat surrounding the electronic circuit during implantation of the electronic circuit in the at least one of the plurality of object by allowing less heat to be transferred to the electronic circuit than an amount of heat to destroy the electronic circuit (FIG. 3);

In another aspect, the RFID tag comprises a tag from Class I, Class II, Class III, or Class IV; and

In another aspect, the plurality of RFID tags comprise more than one class.

### Of Vishwanath

However, the object may be made of plastic or a carbon composite material or a composite of metal and non-metal.

### Of Vishwanath

Class II tags are also passive and generally have extended identification numbers, including additional memory, are rewritable, and include password protection.

### Of Vishwanath

RFID tags could be as small as 0.3 mm or even smaller;

The size of the RFID tag, however, is not limiting; and

That is, the size of the RFID tag may be selected depending on the configuration of the part which is implanted and the use of the RFID tag.

### Of Vishwanath

Embodiments include many useful methods and devices. For example, in one embodiment, implantation of coated RFID tag in metal-containing components allows for the tracking of the individual metal-containing components of an apparatus comprising a plurality of metal-containing objects, as well as the apparatus itself;

Individual metal-containing components can be inventoried prior to assembly and monitored at each stage during shipping in a manner similar to which non-metal packages are currently monitored by commercial shipping companies;

Further, once an apparatus could be assembled using components containing the coated RFID tags, one, several, or all of the coated RFID tags (100) can be monitored to trach the movements of the apparatus; and

Further, in an apparatus comprising several tagged metal-containing components, the apparatus can be monitored to determine if any of the metal-containing components were replaced.

### Of Vishwanath

Another embodiment could comprise the monitoring of the relative tum or a location measure for fixtures such as screws, and nut and bolts (FIG. 5);

A coated RFID tag (100) may be, for example, implanted in the head of a screw;

A RFID monitor may then be configured to monitor the rotation of the screw in a manner similar to monitoring the rotation of a tire on a car or bicycle; and

In this way, passive components may be turned into intelligent components.

### Miscellaneous of Vishwanath

Elaborates on the types of RFID and classes;

Elaborates on the use of plastic; and

Mentions RFID tags could be as small as 0.3 mm or even smaller.

### United States Patent Application Publication Number 2015/0262230 Cypher et al.

United States Patent Application Publication Number 2015/0262230—published to Cypher et al. on Sep. 17, 2015 in U.S. class 705 and subclass 14.49—teaches a system including a computer-readable storage medium storing at least one program and a computer-implemented method for providing an offer based on a level of buying intent of an individual. Consistent with some embodiments, the method includes monitoring an amount of time an individual wears a particular garment while in a fitting room of a retail store, and determining an interest level of the individual in purchasing the garment based on the amount of time the individual wears the garment. The method further includes generating and provisioning an offer to the individual based on the determined level of intent.

In contradistinction to the present invention, Cypher et al. teach at the following location(s):

### Of Cypher et al.

For example, information provided by the client device of the user, facial recognition, a password or pin number, or biometric data; and

The fitting room includes an interactive mirror system that may automatically identify the items brought therein (e.g. the dress, handbag, shirt, and jeans) using, for example, radio frequency identification (RFID) tags affixed to or embedded in the items.

### Of Cypher et al.

As illustrated, the networked retail store system (100) includes a retail store server (102) to provide processing capability and external network connectivity to the networked retail store system (100);

The retail store server (102) may communicate and exchange data within and outside of the networked retail store system (100) that pertains to various functions and aspects associated with the networked retail store system (100) and its users; and

For example, the retail store server (102) may include an inventory module (104) that provides inventory tracking services to the networked retail store system (100).

### Of Cypher et al.

The product display (114) may also include an identification unit (118) capable of identifying items offered for sale by the retail store that is associated to the system (100); and

The identification unit (118) may include an RFID reader capable of requesting and retrieving information from RFID tags or other similar devices that are affixed to or embedded in items offered for sale by the retail store.

### Of Cypher et al.

As illustrated in FIG. 1, the networked retail store system (100) also includes at least one sale associated device (120) (e.g. operated by a sale associated of the retail store) configured to communicate and exchange data over the internal network with the other components of the networked retail store system (100); and

The sales associate application (122) may also work in conjunction with the inventory module (104) to allow associates to monitor the inventory of items at the retail store. In addition, the sales associate application (122) may enable communication with customers using other components of the networked retail store system (100).

### Of Cypher et al.

The networked retail store system (100) also includes an RFID reader (124), a light array (126), and a beacon (128) configured to communicate and exchange data over the internal network with other components of the networked retail store system (100);

Consistent with some embodiments, RFID tags or similar devices may be affixed to, embedded in, or otherwise associated with items offered for sale (e.g., handbags, sunglasses, etc.) it uniquely identifies the items;

The RFID reader (124) may be used to retrieve information from these RFID tags, and in doing so, the RFID reader (124) is capable of identifying items offered for sale;

For example, the RFID reader (124) may transmit a response or interrogator signal that, when in range of a RFID tag, causes the RFID tag to provide a response that includes information about the item to which it is affixed; and

This information may, among other things, include an identifier of the item.

### Of Cypher et al.

The shelves (404) may have one or more embedded identification units (118) for identifying the items (406) and (408) placed thereon;

For example, an RFID tag may be affixed to the items 406 and 408, and the identification unit (118) may include an RFID reader (124) to obtain information from the RFID tags that includes, inter alia, a unique identifier of the items (406) and (408); and

In another example, a tag with a barcode may be affixed to the items (406) and (408), and the identification unit (118) may make use of a barcode scanner to uniquely identify.

### Of Cypher et al.

The product identification module (814) is configured to identify products offered for sale by the retail store in which the interactive mirror display (112) operates;

Each item may be uniquely identified and tracked using the inventory module (104) and information stored in the database (108); and

Each item may be uniquely identified using for example, the product identification module (814) may employ a variety of technologies to identify items such as, but not limited to, an RFID reader (806), a barcode scanner, keypad or other input devices to receive an identifier from individuals, or using image processing and analysis techniques to automatically recognize items from images received from a camera.

### Of Cypher et al.

The feedback information obtained by the feedback module (818) may be recorded and stored as user data that is part of a user account of each user of the networked retail store system (100) or the network-based marketplace (202);

The feedback information may also be monitored by retail stores and anonymously provided to creators of items (e.g., designers, manufacturers, or producers) to provide real-time, localized, and segmented feedback about how specific items are performing within specific demographics;

Inventory can be shifted from one store to the next in a more rapid manner if there is insight into such behavior; and

Further, revisions in product lines can be made if items are not converting to sales.

### Of Cypher et al.

Consistent with some embodiments, the identifying of the item of interest may be based on a signal produced by an RFID tag affixed to the item;

For example, based on the known strength of signals produced by an RFID tag at carious ranges, the identification module (814) may determine that the individual has moved the item from a first position to a second position (e.g., the individual picked up an item or carried the item from one location to another); and

In another example, the identification module (814) may detect the presence of an RFID signal in a particular area of the store where such a signal was not previously detached, and based on this detection the identification module (814) may determine that the individual carried the item into the particular area (e.g., the fitting room (700)).

### Miscellaneous of Cypher et al.

Fails to mention any use or application of the elimination of barcode usage;

Mentions a mirror with an integrated system that uses RFID technology;

Inventory in optical outlets and external cloud-based-system;

Clearly states the affixed embodiment to an item on the store (bags, jewelry, sunglasses, etc.) which is reference as items (406) and (408), but no basis or reference to placing RFID device or tag inside a screw of an item;

Does not disclose any methodology or technology of the RFID design so no measurements, features, etc. can be used as facts or limitations;

Fails to indicate any information or reference to the screw embodiments, the items;

The items and application indicated are traditional retail store items (bags, sunglasses, etc.) no specific reference to sunglass screw embodiment, nor a parallel capacitor; and

Fails to mention anything remote or implying to the programmable logic being read/write or fixed.

It is apparent that numerous innovations for RFID devices have been provided in the prior art that are adapted to be used. Furthermore, even though these innovations may be suitable for the specific individual purposes to which they address, however, they would not be suitable for the purposes of the embodiments of the present invention as heretofore described, namely, an RFID screw specifically for use on eyeglass frames.

### SUMMARY OF THE INVENTION

Thus, an object of the embodiments of the present invention is to provide a RFID device specifically for use on eyeglass frames, which avoids the disadvantages of the prior art.

Another object of the embodiments of the present invention is for screws only related to eyeglass frames and nothing else.

Still another object of the embodiments of the present invention is to provide an RFID device having two parts—electronic devices called readers that send out radio signals, and tags with a small amount of information in them.

Yet still another object of the embodiments of the present invention is that when the reader's radio signal hits the RFID device, the RFID device reflects back a signal with its serial number. In this way, the reader can identify all the RFID devices within a short distance—usually a few meters.

Still yet another object of the embodiments of the present invention is in addition to being able to identify and count all of the RFID devices in a vicinity, the reader can estimate the location of the RFID device. It is used for internal retailer inventory, theft protection, and external inventory that relays the purchase back to the manufacturer or distributor for sales updates in real time.

Yet still another object of the embodiments of the present invention is to use it in the retail eyeglass frame sector, for example, where it counts and manages store inventory.

Still yet another object of the embodiments of the present invention is that barcodes are eliminated. The problem with barcodes in that a person using a barcode reader has the burdens of scanning every item one-by-one, and the tag must be within the line of sight of the reader, so it may be embedded in the tracked object. For a typical mid-sized apparel store with hundreds of unique items, a physical inventory count becomes a big task. The RFID devices of the embodiments of the present invention streamline this task so that retailers can count more often, gaining the benefits of a more accurate inventory.

Even though the “barcodes are eliminated” may be considered a negative limitation by some, it is the only way, and by far the clearest way, to state the limitation, and therefore must be considered in determining patentability. Support for this assertion can be found in the notice entitled “Practice Re: Technical Rejections,” dated Apr. 30, 1965 (814 O.G. 715), which states that:
“The inclusion of a negative limitation shall not, in itself, be considered a sufficient basis for objection to or rejection of a claim.” [Emphasis added]

And, in In re Duva, 156 USPQ 90, 94 (CCPA 1967), where the Court stated:
“[I]t [is] held proper to claim a negative limitation even if a positive expression could have been employed and even at the ‘point of novelty’ . . . .”[Emphasis added]

The fact that barcodes are eliminated and the tag does not have to be within the line of sight of the reader, so it may be embedded in the tracked object is of critical importance and obviously a point of novelty, since it eliminates a person using a barcode reader from having the burden of scanning every item one-by-one, and the tag must be within the line of sight of the reader, so it may be embedded in the tracked object.

In contradistinction, Cypher et al. do use barcodes, as discussed at [0071] of Cypher et al., where it is taught:
“In another example, a paper tag may be affixed to the items 406 and 408, and the identification unit 118 may make use of a barcode scanner to uniquely identify the items 406 and 408.”[Emphasis added]

Examiner Savusdiphol, in the parent application, cites only [0029], 0040], [0041], and [0043] of Cypher et al. to show the elimination of barcodes in Cypher et al.'s invention, but does not cite [0071] which teaches the use of barcodes in the Cypher et al.'s invention, as discussed above.

Yet still another object of the embodiments of the present invention is the development of software that focuses on prevention of theft, tracks inventory within the optical retail outlet, and uses a cloud-based-system to inform select eye-glass-manufacturers and distributors of a sale to improve restocking.

Briefly stated, still yet another object of the embodiments of the present invention is to provide an RFID device that includes an RFID tag inside a custom screw of an eyeglass frame configured to track and identify the eyeglass frame, an antenna inside the custom screw of the eyeglass frame configured to receive a transmitted signal to collect and power the RFID tag, and a programmable logic inside the custom screw of the eyeglass frame configured to process and store transmission and sensor data. Barcodes are eliminated because a person having to use a barcode reader has the burden of scanning every item one-by-one, and assuring that the tag is within the line of sight of the reader.

Yet still another object of the embodiments of the present invention is when the device is activated through a source signal usually a few meters away responds with signal data, including serial number of the eyeglass frame.

Still yet another object of the embodiments of the present invention is that the device further extends the ability to receive multiple signals from multiple devices within range, usually a few meters and transmit a response to a remote managed system that can be used for theft protection and management of internal or external inventory.

Sill yet another object of the embodiments of the present invention is to further includes software that focuses on prevention of theft by taking inventory within an optical retail outlet.

Yet still another object of the embodiments of the present invention is that the RFID device uses a cloud-based-system to inform select eyeglass manufacturers and distributers of a sale to improve restocking.

Still yet another object of the embodiments of the present invention is that components of the RFID device are placed inside a custom screw.

Yet still another object of the embodiments of the present invention is that the RFID device avoids the use of a matching circuit for the antenna and relays on a fine-tuned antenna to power the device.

Still yet another object of the embodiments of the present invention is that the antenna and components of the RFID device must be in resonance that occurs when inductance reactance and capacitance are about equal for achieving maximum possible energy transfer.

Yet still another object of the embodiments of the present invention is that inductance resistance is much less than capacitance.

Still yet another object of the embodiments of the present invention is that bandwidth is at least twice data rate.

Briefly stated, yet still another object of the embodiments of the present invention is to provide an RFID device for use on eyeglass frames that includes a pair of eye wires or rims surrounding and holding a pair of lenses in place in a front frame, a pair of end pieces that connect the pair of eye wires or rims, respectively, via a pair of hinges, respectively, to a pair of temples, respectively. The pair of hinges connect the pair of end pieces of the front frame to the pair of temple/eye pieces, respectively, allow a pivoting movement of the pair of temples with a single RFID screw in one of the hinges of the glasses, the pair of temple/eye pieces on either side of the skull, respectively, are pivotally attached to the pair of end pieces, respectively, by the pair of hinges, respectively, and which includes an integrated circuit for storing and processing information that modulates and demodulates radio-frequency (RF) signals, apparatus for collecting the AC power from an incident reader signal, and an antenna for receiving and transmitting the signal so as to form a transmission. Information from said RFID tag is stored in a non-volatile memory, and barcodes are eliminated because a person having to use a barcode reader has the burden of scanning every item one-by-one, and assuring that the tag is within the line of sight of the reader.

Still yet another object of the embodiments of the present invention is that the device uses the RFID tag that allows read only or read/write instruction.

The embodiments of the present invention themselves, however, both as to their construction and to their method of operation, together with additional objects and advantages thereof, will be best understood from the following description of the embodiments of the present invention when read and understood in connection with the accompanying figures of the drawing.

### BRIEF DESCRIPTION OF THE FIGURES OF THE DRAWING

FIG. 1 is a diagrammatic perspective view of an example of a single prior art screw with tag;

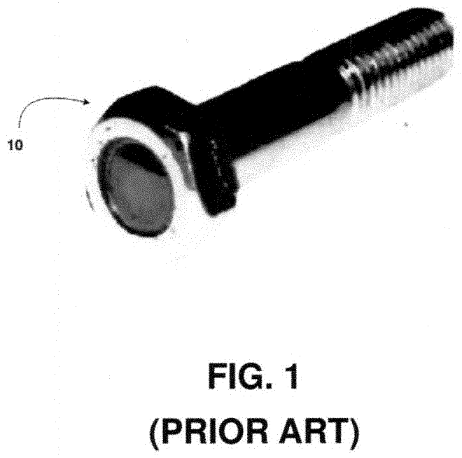

FIG. 2 is a diagrammatic perspective view of an example of a pair of prior art screws with tags;

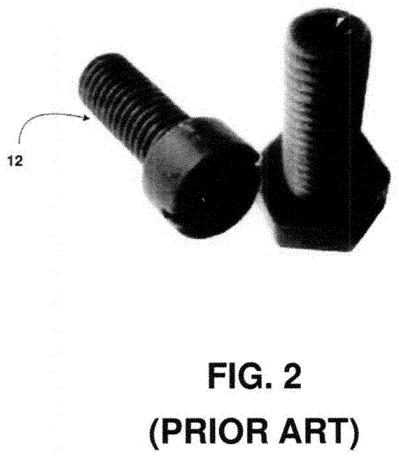

FIG. 3 is a diagrammatic example of a binary tree method of identifying a prior art RFID tag;

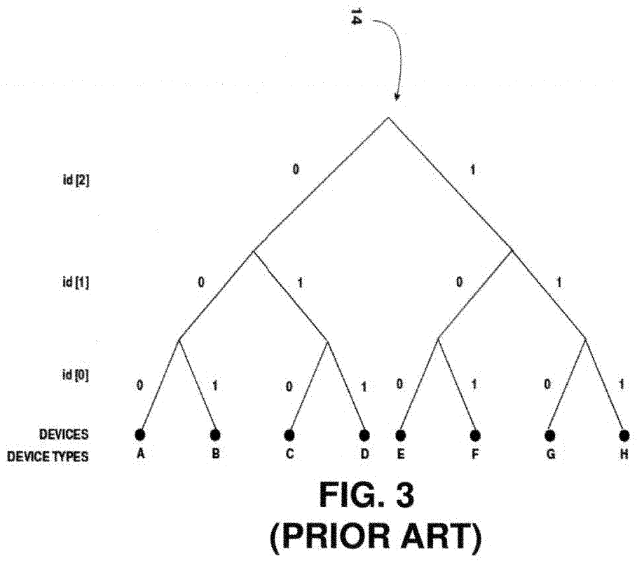

FIG. 4 is a diagrammatic perspective view of a pair of glasses utilizing the screw with the RFID device of the embodiments of the present invention;

FIG. 5 is an enlarged diagrammatic perspective view of the area generally enclosed by the dotted curve identified by ARROW 5 in FIG. 4 of the hinge of the pair of glasses shown in FIG. 4 utilized with the screw with the RFID device of the embodiments of the present invention;

FIG. 6 is a diagrammatic side elevational view of the screw with the RFID device of the embodiments of the present invention;

FIG. 7 is an enlarged diagrammatic cross-sectional view taken along LINE 7-7 of FIG. 6;

FIG. 8 is an enlarged diagrammatic cross-sectional view taken along LINE 8-8 of FIG. 6;

FIG. 9 is an enlarged diagrammatic cross-sectional view taken along LINE 8-8 of FIG. 6;

FIGS. 10A, 10B, 10C and 10D are diagrammatic top plan views illustrating different configurations for the antenna; and

FIG. 11 is a flowchart of the workflow of the RFID device of the embodiments of the present invention.

### LIST OF REFERENCE NUMERALS UTILIZED IN FIGURES OF DRAWING

### Background of Invention

### Description of Prior Art

10 prior art RFID tag
12 pair of prior art RFID tags
14 binary tree method of identifying an RFID tag

### DETAILED DESCRIPTION OF THE PREFERRED EMBODIMENTS

### Pertinent Parts of Eyeglass Frame 22

22 eyeglass frame
24 pair of eye wires or rims
26 pair of lenses
28 front frame
30 pair of end pieces
32 pair of hinges
34 pair of temples

### Configuration of Screw with RFID Device 40

40 screw with RFID device
42 integrated circuit for storing and processing information that modulates and demodulates radio-frequency (RF) signals
44 apparatus for collecting AC power signal from incident reader signal
46 antenna for receiving and transmitting signal
46a 0.36 A straight dipole antenna of antenna 46
46b ink-reducing 0.36 A straight dipole antenna of antenna 46
46c meander dipole antenna of antenna 46
46d ink-reducing 0.25 A meander dipole antenna of antenna 46
48 non-volatile memory
50 fixed or programmable logic for processing transmission and sensor data, respectively
52 PCB
54 chip
56 capacitor
58 custom screw
60 work flow

### DETAILED DESCRIPTION OF THE PREFERRED EMBODIMENTS

### Pertinent Parts of an Eyeglass Frame 22

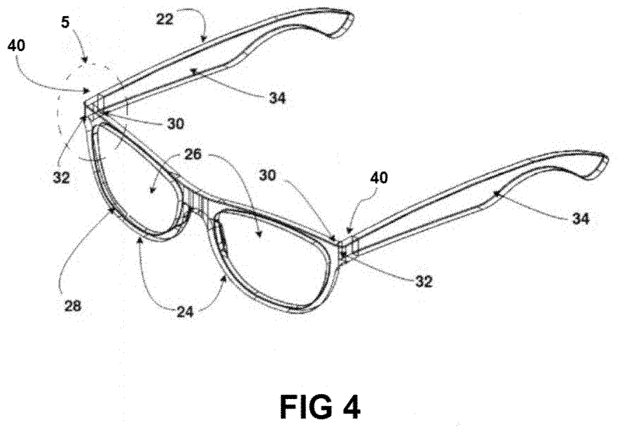

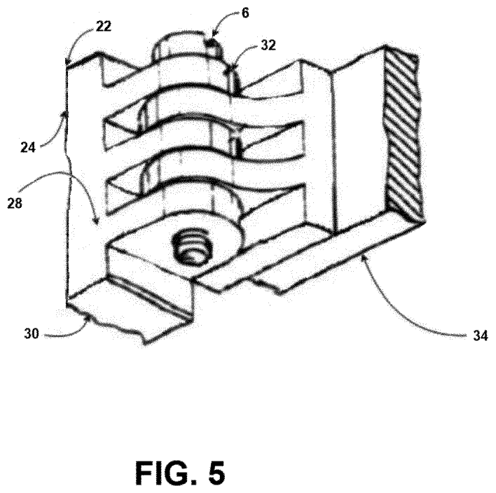

Referring now to FIGS. 4 and 5, an eyeglass frame is shown generally at 22.

The pertinent parts of the eyeglass frame 22 include:

A pair of eye wires or rims 24 surrounding and holding a pair of lenses 26 in place in a front frame 28;

A pair of end pieces 30 that connect the pair of eye wires or rims 24, respectively, via a pair of hinges 32, respectively, to a pair of temples 34, respectively;

The pair of hinges 32 connecting the pair of end pieces 30 of the front frame 28 to the pair of temple/eye pieces 34, respectively, allow a pivoting movement of the pair of temples 34, with a pair of RFID devices, respectively, of the embodiments of the present invention being a pair of hinge pins thereof, respectively; and

The pair of temple/eye pieces 34 on either side of the skull, respectively, pivotally attach to the pair of end pieces 30, respectively, by the pair of hinges 32, respectively.

### Configuration of the Screw with the RFID Device 40

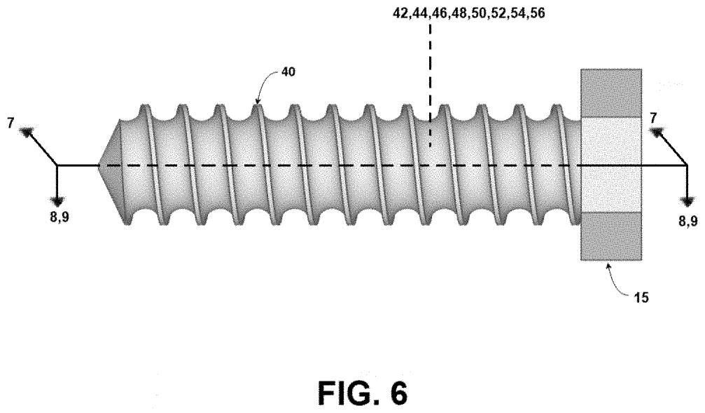

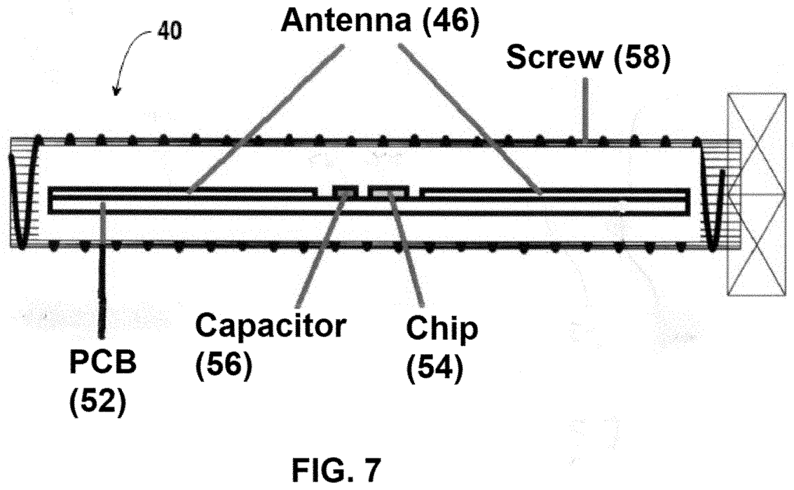

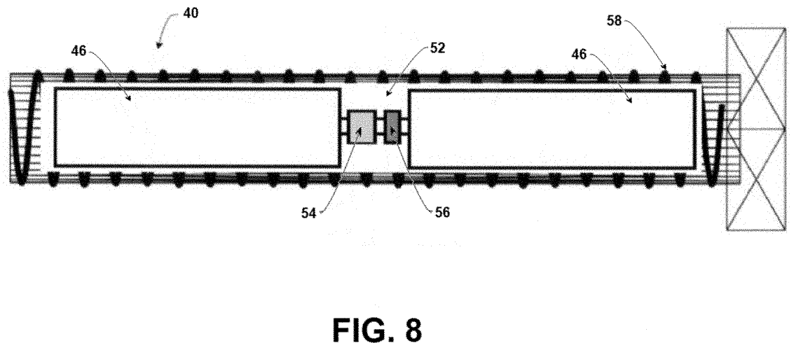

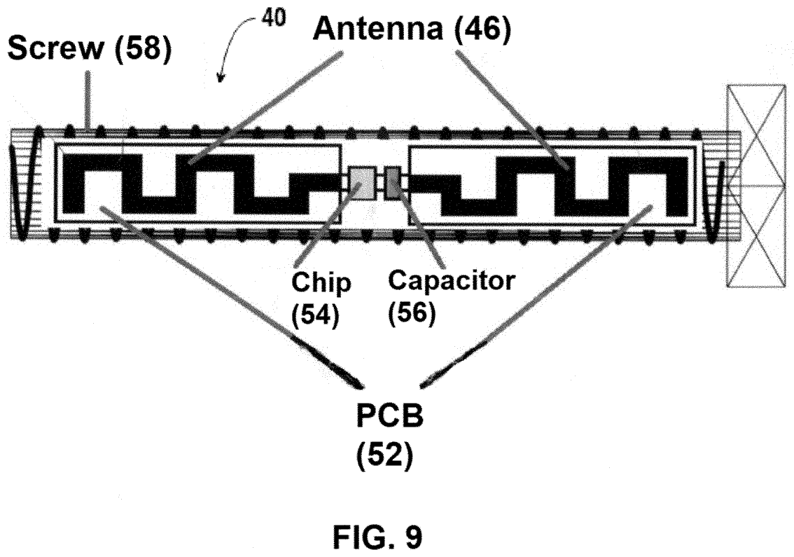

The configuration of the screw with the RFID device 40 can best be seen in FIGS. 6, 7, 8, 9, 10a, 10b, and 10c, and as such, will be discussed with reference thereto.

The screw with the RFID device 40 comprises an integrated circuit 42 for storing and processing information that modulates and demodulates radio-frequency (RF) signals, apparatus 44 for collecting the AC power signal from an incident reader signal, and an antenna 46 for receiving and transmitting the signal. Information is stored in a non-volatile memory 48 of the screw with the RFID device 40, and barcodes are eliminated because a person having to use a barcode reader has the burden of scanning every item one-by-one, and assuring that the tag is within the line of sight of the reader.

Even though the “barcodes are eliminated” may be considered a negative limitation by some, it is the only way, and by far the clearest way, to state the limitation, and therefore must be considered in determining patentability. Support for this assertion can be found in the notice entitled “Practice Re: Technical Rejections,” dated Apr. 30, 1965 (814 O.G. 715), which states that:
“The inclusion of a negative limitation shall not, in itself, be considered a sufficient basis for objection to or rejection of a claim.” [Emphasis added]

And, in In re Duva, 156 USPQ 90, 94 (CCPA 1967), where the Court stated:
“[I]t [is] held proper to claim a negative limitation even if a positive expression could have been employed and even at the ‘point of novelty’ . . . ”[Emphasis added]

The fact that barcodes are eliminated and the tag does not have to be within the line of sight of the reader, so it may be embedded in the tracked object is of critical importance and obviously a point of novelty, since it eliminates a person using a barcode reader from having the burden of scanning every item one-by-one, and the tag must be within the line of sight of the reader, so it may be embedded in the tracked object.

In contradistinction, Cypher et al. do use barcodes, as discussed at [0071] of Cypher et al., where it is taught:
“In another example, a paper tag may be affixed to the items 406 and 408, and the identification unit 118 may make use of a barcode scanner to uniquely identify the items 406 and 408.”[Emphasis added]

Examiner Savusdiphol, in the parent application, cites only [0029], 0040], [0041], and [0043] of Cypher et al. to show the elimination of barcodes in Cypher et al.'s invention, but does not cite [0071] which teaches the use of barcodes in the Cypher et al.'s invention, as discussed above.

The screw with the RFID device 40 includes either fixed or programmable logic 50 for processing the transmission and sensor data, respectively.

The integrated circuit 42 is mounted on a PCB 52, including a chip 54 and a capacitor 56, and the antenna 46.

The PCB 52 extends axially in the screw, and the antenna 46 is a sticker for design interchangeability.

The chip 54 and the capacitor 56 are disposed generally centrally on the PCB 52, with the antenna 46 straddling them. This design maximizes real estate within the screw.

In order to have read/write ability, the screw with the RFID device 40 uses a class 2 gen IC (the SL3S12-5-15-DS IC). The antenna 46 is embedded or placed inside the screw.

The RFID tag 20 is made of one of high-end plastic and silver ink.

The antenna 46 utilizes near field magnetic induction coupling at 915 MHz, with the integrated circuit being SL3S1205_15. Said design approach is applicable on various frequencies and not limited to 915 MHz including HF and UHF frequencies.

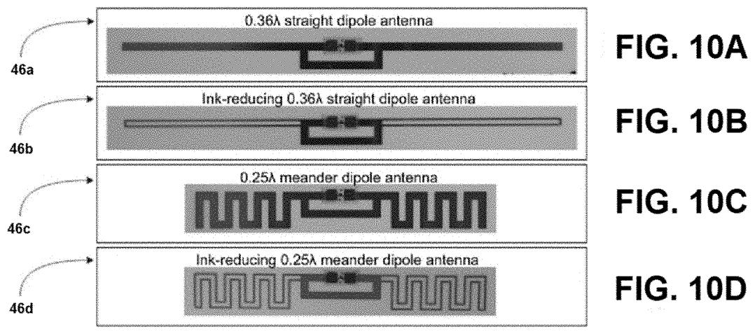

As shown in FIG. 10A, the antenna 46 is configured as a 0.36 A straight dipole antenna 46a.

As shown in FIG. 10B, the antenna 46 is configured as an ink-reducing 0.36 A straight dipole antenna 46b.

As shown in FIG. 10C, the antenna 46 is configured as a 0.25 A meander dipole antenna 46c.

As shown in FIG. 10D, the antenna 46 is configured as an ink-reducing 0.25 A meander dipole antenna 46d.

The reason why it is imperative to have the RFID device embedded in a mini eyeglass screw, ergo, the name “screw with the RFID device,” is the inventory and transportation process can be tracked from the manufacturing to the distribution to the retail inventory (including tracking of theft), and then when a sale is made in which case the information will then be sent back to the manufacturer/distributor. This allows all the manufacturers of frames to participate, whereas the patch or RFID wrap around the frame will only be supported by a small number of manufacturers and retailers. The one thing all frame manufacturers use are the mini screws. It would be a large disadvantage to get manufacturers to change the way they are already producing frames for them to add an additional component to the frame, such as, the screw with the RFID device 40.

Hitachi—the Japanese semiconductor company—has unveiled a prototype for the next generation of its μ-Chip (pronounced mu-chip). The chip is just 0.3 millimeters square.

### Space Available

The RFID device components are placed inside a custom screw 58 that is based on “Safe-Lok™ Hinge & Eye wire Screw—Part #275015300.”

The measurements of the custom screw 58 are as follows:

Head Diameter—2.0 mm;

Screw Diameter—1.4 mm; and

Screw Length—3.5 mm.

### Approach

Considering the limited space for the application, a true antenna will be a complex task to devise. The antenna 46 is devised to resonate at the frequency of interest (915 MHz). The antenna 46 will utilize near field magnetic induction coupling between the source transmitter and the receiving antenna to activate the passive tag device mounted. Hence the antenna 46 is designed to maximize the induced voltage, targeted read range is 30 cm.

### Tag Chip Specs

The chip 54 chosen for this application is UCODE 8m ICs model SL3S1205_15. Infra, are the technical details based on the provider's datasheet:

### Mechanical Details

Die to Die distance (metal sealring-metal sealring) 21.4 μm, (X-scribe line width: 15 μm);

Die to Die distance (metal sealring-metal sealring) 21.4 μm, (Y-scribe line width: 15 μm);

Chip step, Y-length: 490 μm;

Chip step, X-length: 480 μm;

Bump to bump distance X (RF1-RF2): 115 μm;

Distance bump to metal sealring Y: 23.5 μm;

Bump size (TP1, TP2) Y: 100 μm;

Bump to bump distance Y (RF1-TP2, RF2-TP1): 50 μm;

Bump size (RF1, RF2) Y: 278 μm;

Distance bump to metal sealring X: 23.5 μm;

Bump size (TP1, TP2) X: 134.2 μm;

Bump size (RF1, RF2) X: 151.5 μm; and

Distance bump to metal sealring Y: 441.5 μm.

### RF Interface Characteristics

All parameters and conditions listed are based on the system application of the embodiments of the present invention from SL3S1205_15 datasheet.

### Parameters and Their Associated Values

Input Frequency is 915 MHz;

Minimum Input Power (Read Sensitivity) is −22.9 dBm;

Minimum Input Power (Write Sensitivity) is −17.8 dBm;

Chip Input Capacitance is 0.69 pF;

Chip Impedance is 14-j242 (at 915 MHz);

Typical Assembled Impedance is 19-j234 (at 915 MHz); and

Typical Assembled Impedance in case of Single-Slit Antenna Assembly is 13-j191 (at 915 MHz).

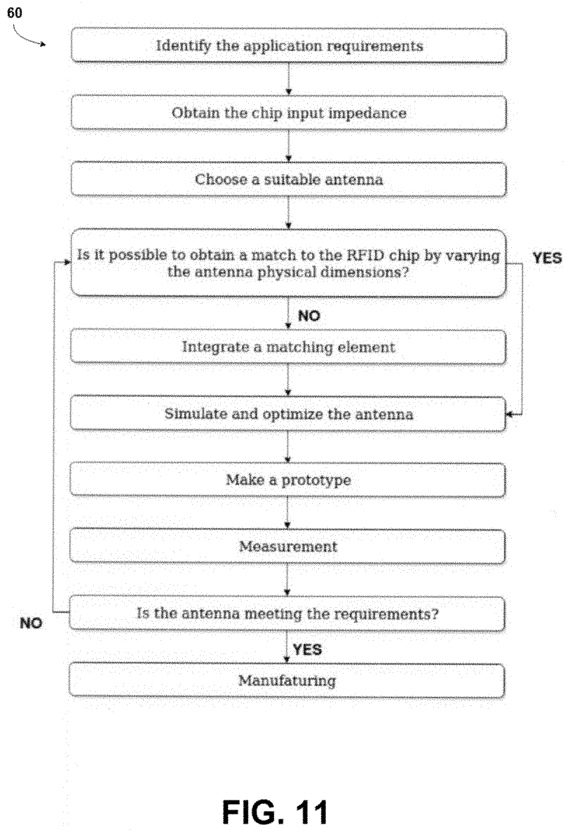

Note: It is always recommended to modify the designed antenna's physical properties as to have the antenna 46 connected directly to the load (avoiding the use of a matching circuit). Please refer to the FIG. 11 for the work flow 60 for this attempt.

The IC datasheet indicates the chip input capacitance condition to be a parallel connection.

To achieve the maximum possible energy transfer, the antenna 46 and components must be in resonance that occurs when the inductance reactance and the capacitances are about equal.

The capacitive reactance can be calculated as (the capacitance value C is provided by the chip datasheet):

$${X}_{C} = \frac{1}{2 π fC}$$

$${X}_{C} = \frac{1}{2 \times π \times ( 915 \times {10}^{6} ) \times ( 0.69 \times {10}^{- 12} )}$$

$${X}_{C} = 252.0867$$

The inductive reactance is calculated as:

X_{L}=2πfL

X_{L}=2×π×(915×10⁶)×(8.524×10⁻⁹)

X_{L}=49.0054

The inductive reactance is much less than the capacitance. The two equations will be equated to find the best inductance.

$${X}_{L} = {X}_{C}$$

$$2 π fL = 252.0867$$

$$L = \frac{252.0867}{2 \times π \times ( 915 \times {10}^{6} )}$$

$$L = 4.39 \times {10}^{- 8} H$$

To verify the resonance frequency of the circuit for the calculated inductance and tuning capacitance used for the tag:

$$\pm {f}_{o} = \frac{1}{2 π \sqrt{LC}}$$

$${f}_{o} = \frac{1}{2 \times π \times \sqrt{( 43.9 \times {10}^{- 9} ) \times ( 0.69 \times {10}^{- 12} )}}$$

$${f}_{o} = 914457078.8 Hz$$

$${f}_{o} = 914.46 MHz$$

It can be seen that rounding roughly raises a 0.059% error margin from 915 MHz. Hence we can proceed with these values.

From the datasheet of the IC, the minimum write cycle endurance is 100 k cycles (100 KHz).

Thus, the bandwidth needs at least twice of the data rate.

The Q factor can be obtained as:

$${Q}_{max} = \frac{{f}_{o}}{B}$$

$${Q}_{max} = \frac{915 \times {10}^{6}}{200 \times {10}^{3}}$$

$${Q}_{max} = 4575$$

### Impressions

It will be understood that each of the elements described above, or two or more together, may also find a useful application in other types of constructions differing from the types described above.

While the embodiments of the present invention have been illustrated and described as an RFID device specifically for use on eyeglass frames, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. An RFID device, comprising:
a) an RFID tag inside a custom screw of an eyeglass frame configured to track and identify the eyeglass frame;
b) an antenna inside the custom screw of the eyeglass frame configured to receive a transmitted signal to collect and power said RFID tag; and
c) a programmable logic inside the custom screw of the eyeglass frame configured to process and store transmission and sensor data;
wherein barcodes are eliminated because a person using a barcode reader has the burden of scanning every item one-by-one, and assuring that the tag is within the line of sight of the reader.

2. The device of claim 1, wherein when said device is activated through a source signal usually a few millimeters to meters away responds with signal data, including serial number of the eyeglass frame.

3. The device of claim 2, wherein said device further extends the ability to receive multiple signals from multiple said devices within range, usually a few millimeters to meters and transmit a response to a remote managed system which can be used for theft protection and management of internal or external inventory.

4. The device of claim 2, further comprising software that focuses on prevention of theft by taking inventory within an optical retail outlet; and
wherein said RFID device uses a cloud-based-system to inform select eyeglass manufacturers and distributers of a sale to improve restocking.

5. The RFID tag of claim 2, wherein components of said RFID device are placed inside the custom screw.

6. The RFID device of claim 2, wherein said device avoids the use of a matching circuit for said antenna and relays on a fine-tuned antenna to power said device.

7. The RFID device of claim 2, wherein said antenna and components of said RFID device must be in resonance that occurs when inductance reactance and capacitance are about equal for achieving maximum possible energy transfer.

8. The RFID device of claim 2, wherein inductance resistance is much less than capacitance.

9. The RFID device of claim 2, wherein bandwidth is at least twice data rate.

10. An RFID device for use on eyeglass frames, wherein the eyeglass frame includes a pair of eye wires or rims surrounding and holding a pair of lenses in place in a front frame, a pair of end pieces that connect the pair of eye wires or rims, respectively, via a pair of hinges, respectively, to a pair of temples, respectively, wherein the pair of hinges connecting the pair of end pieces of the front frame to the pair of temple/eye pieces, respectively, allow a pivoting movement of the pair of temples with a single RFID screw in one of the hinges of the glasses, wherein the pair of temple/eye pieces on either side of the skull, respectively, are pivotally attached to the pair of end pieces, respectively, by the pair of hinges, respectively, and wherein said RFID tag comprising:
a) an integrated circuit for storing and processing information that modulates and demodulates radio-frequency (RF) signals;
b) means for collecting the DC power from an incident reader signal; and
c) an antenna for receiving and transmitting the signal so as to form a transmission;
wherein information from said RFID tag is stored in a non-volatile memory; and
wherein barcodes are eliminated because a person using a barcode reader has the burden of scanning every item one-by-one, and assuring that the tag is within the line of sight of the reader.

11. The RFID device of claim 10, wherein said device uses said RFID tag that allows read only or read/write instruction.

12. The device of claim 10, wherein said device is applicable on various frequencies and not limited to 915 MHz including HF and UHF frequencies.
